(19) United States
(12) Patent Application Publication
(10) Pub. No.: US 2022/0193946 A1
(43) Pub. Date: Jun. 23, 2022

(54) Printing Method and Printing System

(71) Applicant: Putzmeister Engineering GmbH, Aichtal (DE)

(72) Inventors: Jens HAEFNER, Stuttgart (DE); Tobias HUTH, Stuttgart (DE); Knut KASTEN, Ostfildern (DE); Peter MOEGLE, Leinfelden (DE)

(21) Appl. No.: 17/593,783

(22) PCT Filed: Mar. 25, 2020
(86) PCT No.: PCT/EP2020/058311

§ 371 Date: Sep. 24, 2021

(30) Foreign Application Priority Data
Mar. 27, 2019 (DE) 10 2019 204 244.9

(51) Int. Cl. B28B 1/00; B28B 3/24; E04G 21/04; F04B 1/02; F04B 15/02; F04B 7/00

(52) U.S. Cl. CPC B28B 1/001; B28B 3/24; E04G 21/0463; B33Y 30/00; F04B 15/02; F04B 7/0023; F04B 1/02

(57) ABSTRACT

A printing method forms a continuous strand of building material for 3D printing of a structural part via a printing system. The printing system has a printing apparatus that dispenses building material out of the printing apparatus and shapes building material to form a strand of building material, and a discontinuous building material pump that discontinuously conveys building material for discontinuously dispensing conveyed building material out of the printing apparatus. The printing method includes the steps of: a) discontinuously conveying building material via the discontinuous building material pump and discontinuously dispensing conveyed building material out of the printing apparatus and shaping conveyed building material via the printing apparatus, and b) discontinuously moving the printing apparatus during the discontinuous conveying and the discontinuous dispensing such that the dispensed and shaped building material forms a continuous strand of building material.

### FIELD OF APPLICATION AND PRIOR ART

The invention relates to a printing method for forming a continuous strand of building material for 3D printing of a structural part by means of a printing system, and to a printing system for forming a continuous strand of building material for 3D printing of a structural part.

### PROBLEM AND SOLUTION

The problem addressed by the invention is that of providing a printing method for forming a continuous strand of building material for 3D printing of a structural part by means of a printing system, and providing a printing system for forming a continuous strand of building material for 3D printing of a structural part, which in particular in each case has improved characteristics, in particular allows more degrees of freedom.

The invention solves this problem through the provision of a printing method and a printing system having the features of the independent claims. Advantageous refinements and/or configurations of the invention are described in the dependent claims.

The in particular automatic printing method according to the invention is designed or configured or provided for forming an in particular spatially continuous strand of building material for 3D printing of an in particular 3-dimensional structural part by means of a printing system. The printing system has a printing apparatus and a discontinuous building material pump. The printing apparatus is designed or configured to in particular automatically dispense building material out of the printing apparatus and to shape building material, in particular at a time before and/or during the dispensing, in order to form a, in particular the, strand of building material. The discontinuous building material pump is designed or configured to in particular automatically in particular chronologically discontinuously convey or pump building material for the purposes of in particular chronologically discontinuously dispensing conveyed and in particular shaped building material out of the printing apparatus. The printing method has the following steps: a) in particular automatically discontinuously conveying building material by means of the discontinuous building material pump and in particular automatically discontinuously dispensing conveyed building material out of the printing apparatus and shaping conveyed building material, in particular at a time before and/or during the dispensing, by means of the printing apparatus, and b) in particular automatically and/or at least translationally discontinuously moving the printing apparatus during the discontinuous conveying and the discontinuous dispensing, and in particular the shaping, such that the dispensed and shaped building material forms a, in particular the, continuous strand of building material.

In particular, continuously can mean steadily, uninterruptedly, in a gaplessly coherent manner, contiguously, in non-stop fashion, uniformly and/or constantly. Additionally or alternatively, discontinuously can mean non-steadily, interruptedly, with gaps, incoherently, non-uniformly and/or non-constantly.

The continuous strand may extend over an in particular certain length.

The building material may be concrete, in particular fresh concrete, and/or thixotropic and/or set or dimensionally stable, in particular during the dispensing and/or at a time after the shaping. Further additionally or alternatively, the building material may have a maximum grain size of a minimum of 4 millimeters (mm), in particular of a minimum of 10 mm, in particular of a minimum of 16 mm.

3D printing can be referred to as additive manufacturing. Additionally or alternatively, the strand may be deposited or applied, in particular in layers, on or onto an already printed strand, and/or a further strand may be deposited or applied, in particular in layers, on or onto the strand.

The structural part may be a building structural part and/or a wall and/or a ceiling. Additionally or alternatively, the strand, in particular a width of the strand, may have the thickness, in particular the entire thickness, of the wall and/or ceiling.

The printing apparatus can be referred to as a print head and/or dispensing element. Additionally or alternatively, the printing apparatus may be designed to dispense building material out of the printing apparatus in a non-vertical, in particular horizontal, dispensing direction. In other words: the printing apparatus may, or does not need to, be designed to dispense building material out of the printing apparatus in a vertical dispensing direction. Further additionally or alternatively, the printing apparatus may have a discharge opening for the discharge of building material out of the printing apparatus. In particular, the discharge opening may be planar or flat. Further additionally or alternatively, the discharge opening may have an in particular maximum opening width of a minimum of 100 mm, in particular a minimum of 200 mm, and/or a maximum of 800 mm, in particular a maximum of 600 mm, in particular 400 mm, in particular in a first peripheral direction, in particular non-parallel, in particular orthogonally, with respect to a dispensing direction. Further additionally or alternatively, the discharge opening may have an, in particular maximum, opening height of at least 15 mm, in particular at least 25 mm, and/or at most 400 mm, in particular at most 200 mm, in particular at most 100 mm, in particular 50 mm, in particular in a second peripheral direction, in particular non-parallel, in particular orthogonally, with respect to a dispensing direction and/or the first peripheral direction.

The discontinuous building material pump may, or does not need to, be designed to continuously convey building material, in particular to continuously dispense conveyed building material out of the printing apparatus, in particular not a screw pump.

The printing method thus makes it possible for the in particular possibly already existing discontinuous building material pump to be used directly for 3D printing. The printing method thus has improved characteristics, in particular allows more degrees of freedom.

In one refinement of the invention, the discontinuous building material pump is designed or configured to convey building material, in particular with an in particular continuous conveying volume flow, in displacement cycles. In suction and/or switchover cycles, in particular of the building material pump, in particular chronologically between the displacement cycles, a, in particular the, conveying volume flow, in particular a value or magnitude of the conveying volume flow, of building material of the building material pump is in particular chronologically discontinuously in particular equal to zero or suspended. In other words: although the building material pump may be in operation, the conveying volume flow may be discontinuous, in particular in the suction and/or switchover cycles. In particular, the conveying volume flow may differ, in particular be smaller, at the beginning and/or at the end in relation to a middle of a, in particular each, displacement cycle.

In particular, the discontinuous building material pump may be a rotor pump.

In one refinement of the invention, the discontinuous building material pump is a piston pump, in particular a two-piston pump with an in particular switchable pipe switch or a concrete valve. In particular, in the case of a single-piston pump, the conveying volume flow may be discontinuous in suction cycles. Additionally or alternatively, in the case of a two-piston pump with a pipe switch, the conveying volume flow may be discontinuous in switchover cycles.

In one embodiment of the invention, step a) has: in particular automatically switching the pipe switch so slowly that the switching of the pipe switch does not cause the printing apparatus to vibrate. This can make it possible to avoid in particular unintentional damage to the strand.

In one refinement of the invention, the printing apparatus is designed or configured to in particular automatically specify, in particular specify the shape of, a strand cross section, in particular an area of the strand cross section, of the strand. Step b) comprises: in particular automatically discontinuously moving the printing apparatus such that the strand formed has the specified strand cross section, in particular the strand cross section specified by the printing apparatus. In particular, the strand cross section may be non-parallel, in particular orthogonal, with respect to the dispensing direction.

In one embodiment of the invention, the printing apparatus has, in particular the, at least one discharge opening with at least one shape-imparting opening cross section. The at least one discharge opening is designed or configured for the particular automatic discharge of the strand, in particular with the strand cross section, of building material out of the printing apparatus. Step a) comprises: in particular automatic discontinuous discharge of the strand, in particular with the strand cross section, of building material out of the printing apparatus. Step b) comprises: in particular automatically discontinuously moving the printing apparatus such that the strand cross section, in particular a shape and/or a size of the strand cross section, of the discharged strand equates, in particular entirely, to the at least one opening cross section, in particular to a shape and/or a size of the opening cross section. In particular, the printing method may be referred to as an extrusion method and/or the printing system may be referred to as an extruder system and/or the printing apparatus may be referred to as an extruder apparatus. In particular, the extruder apparatus may have an extruder nozzle, wherein the extruder nozzle may have the discharge opening. In particular, the extruder nozzle, in particular the discharge opening, may be tubular and/or peripherally closed, in particular in/counter to the at least one peripheral direction, in particular by at least one peripheral wall. Additionally or alternatively, the extruder nozzle may have the discharge opening at an in particular face-side and/or front end. Further additionally or alternatively, the discharge opening can be referred to as a dispensing opening. Further additionally or alternatively, the discharge opening may have a quadrangular shape, in particular a trapezoidal shape, in particular a parallelogram shape, in particular a rectangular shape. Further additionally or alternatively, the extruder nozzle may specify the dispensing or discharge direction of the strand of building material out of the extruder apparatus, in particular the extruder nozzle, in particular the discharge opening. In particular, the dispensing direction may be parallel, in particular coaxial, with respect to a longitudinal axis of the extruder nozzle. Further additionally or alternatively, the strand cross section, in particular a shape and/or a size of the strand cross section, may at least partially, in particular entirely, correspond, in particular equate, to a flow cross section, in particular a shape and/or a size of the flow cross section, of building material within the extruder nozzle. Further additionally or alternatively, the opening cross section and/or the flow cross section may in particular each be non-parallel, in particular orthogonal, with respect to the dispensing direction.

In one embodiment of the invention, the printing apparatus is designed or configured to be in particular continuously adjustable for the purposes of in particular automatically in particular continuously adjustably specifying the strand cross section, in particular of the at least one shape-imparting opening cross section, in particular during the dispensing, in particular discharge, of building material. The printing method has the following step: in particular automatically adjusting the specification of the strand cross section, in particular of the at least one opening cross section, in particular during the dispensing, in particular discharge, of building material. Step b) comprises: in particular automatically discontinuously moving the printing apparatus in a manner dependent on the adjusted specification of the strand cross section, in particular of the at least one opening cross section. This allows different strand cross sections, in particular different shapes and/or sizes of the strand cross section or of the strand cross sections. In particular, this can allow the implementation of different wall and/or ceiling thicknesses, in particular with a transition without a shoulder, and/or the printing of the structural part with slots, holes or channels, in particular for lines or cables and/or pipes or for media such as electricity and/or water. These therefore do not need to be produced, in particular in laborious fashion, if this is possible at all with reasonable effort, at a time after the printing, in particular by work operatives.

In one refinement of the invention, step a) comprises: in particular automatically discontinuously dispensing, in particular discontinuous discharging of, building material out of the printing apparatus in an, in particular the and/or non-vertical, in particular horizontal, dispensing direction. Step b) comprises: in particular automatically discontinuously moving the printing apparatus in a movement direction which is non-orthogonal, in particular reversed, in particular opposite, with respect to the dispensing direction. In particular, reversed can mean a minimum of 135 degrees)(°, in particular a minimum of 150°, in particular 165°. Additionally or alternatively, opposite can mean 180°.

In one refinement of the invention, step b) comprises: in particular automatically discontinuously moving the printing apparatus in a manner dependent on the discontinuous conveying and the discontinuous dispensing. In particular, the discontinuous movement of the printing apparatus may be synchronous with the discontinuous conveying and the discontinuous dispensing.

In one embodiment of the invention, step a) comprises: in particular automatically discontinuously conveying building material with a, in particular the, discontinuous conveying volume flow and/or in particular automatically discontinuously dispensing building material out of the printing apparatus with a discontinuous dispensing volume flow and/or a discontinuous dispensing speed, in particular discharge speed.

In addition, step b) has: in particular automatically discontinuously moving the printing apparatus at a discontinuous movement speed in such a way that the movement speed, in particular a value or magnitude of the movement speed, in particular over a certain time period, is proportional to the conveying volume flow, in particular a value or magnitude of the conveying volume flow, and/or to the dispensing volume flow, in particular a value or magnitude of the dispensing volume flow, in particular equal to the dispensing volume flow divided by the strand cross section, in particular a value or magnitude of an area of the strand cross section, or the opening cross section, in particular a value or magnitude of an area of the opening cross section.

Additionally or alternatively, step b) has: in particular automatically discontinuously moving the printing apparatus at a discontinuous movement speed such that the movement speed, in particular a value or magnitude of the movement speed, in particular over a certain time period, is proportional to the dispensing speed, in particular a value or magnitude of the dispensing speed, in particular equal to the dispensing speed.

This allows the strand formed to have the specified strand cross section, in particular the at least one opening cross section.

In one refinement of the invention, the printing method has the step: in particular automatically depositing the dispensed building material. Step b) comprises: in particular automatically discontinuously moving the printing apparatus such that the deposited building material forms the continuous strand of building material.

In particular, the depositing of the dispensed building material may be such that the deposited strand may have the specified strand cross section, in particular the at least one opening cross section, or may maintain its strand cross section, in particular of the discharged strand. In other words: the building material may, or does not need to, be printed onto an already existing building material layer or layer and thus deformed.

The printing system according to the invention for forming a, in particular the, in particular spatially continuous strand of building material for 3D printing of a, in particular the, structural part has a, in particular the, printing apparatus, a, in particular the, discontinuous building material pump, a controllable movement apparatus and an in particular electrical control device, in particular a computer. The printing apparatus is designed or configured to in particular automatically dispense building material out of the printing apparatus and to shape building material, in particular at a time before and/or during the dispensing, in order to form a, in particular the, strand of building material. The discontinuous building material pump is designed or configured to in particular automatically in particular chronologically discontinuously convey or pump building material for the purposes of discontinuously dispensing conveyed and in particular shaped building material out of the printing apparatus. The movement apparatus is designed or configured to in particular automatically and/or at least translationally discontinuously move the printing apparatus. The control device is designed or configured to in particular automatically and/or independently control the movement apparatus so as to in particular at least translationally discontinuously move the printing apparatus during the discontinuous conveying and the discontinuous dispensing, and in particular the shaping, such that the dispensed and shaped building material forms a, in particular the, continuous strand of building material.

The printing system can provide the same advantage(s) as the printing method described above.

In particular, the printing system may be designed or configured to in particular automatically carry out or perform the printing method described above. Additionally or alternatively, the printing system, the printing apparatus and/or the discontinuous building material pump may in particular each be partially or even fully designed or configured as described above for the printing method. Further additionally or alternatively, the movement apparatus can be referred to as a positioning apparatus. Further additionally or alternatively, the movement apparatus and/or the printing apparatus may be designed to in particular automatically move the printing apparatus in rotation, in particular during the conveying and/or the dispensing and in particular the shaping. Further additionally or alternatively, the printing apparatus may be carried by the movement apparatus.

In one refinement of the invention, the movement apparatus has a controllable arm. The arm is designed or configured to in particular automatically discontinuously move the printing apparatus. The control device is designed or configured to in particular automatically and/or independently control the arm so as to discontinuously move the printing apparatus during the discontinuous conveying and the discontinuous dispensing, and in particular the shaping, such that the dispensed and shaped building material forms the continuous strand of building material. In particular, the arm may be a robot arm and/or a mast.

In one refinement of the invention, the printing system has a building material conveying line. The building material conveying line connects the building material pump to the printing apparatus for a flow of building material from the building material pump through the building material conveying line to the printing apparatus.

In one refinement of the invention, the printing system is a controllable printing system. Additionally or alternatively, the printing apparatus is a controllable printing apparatus. Additionally or alternatively, the building material pump is a controllable building material pump. Additionally or alternatively, the control device is designed or configured to in particular automatically and/or independently control the in particular controllable printing system and/or the in particular controllable printing apparatus and/or the in particular controllable building material pump and/or the in particular controllable movement apparatus in a manner dependent on data, in particular a building or construction plan, in particular in a memory of the control device, of the structural part to be printed. This makes it possible that a work operative does not need to control the printing system, and/or that errors during the construction process can be reduced or even avoided.

### BRIEF DESCRIPTION OF THE DRAWINGS

Further advantages and aspects of the invention will emerge from the claims and from the following description of preferred exemplary embodiments of the invention, which are discussed below with reference to the figures.

FIG. 1 schematically shows a printing method according to the invention and a printing system according to the invention.

FIG. 2 schematically shows a two-piston pump with a pipe switch of the printing system of FIG. 1.

FIG. 3 schematically shows once again the printing method of FIG. 1 and a movement apparatus of the printing system of FIG. 1.

FIG. 4 schematically shows a conveying volume flow and a dispensing volume flow of the printing method and the printing system of FIG. 1 over time, a switching state of the pipe switch of FIG. 2 over time and a movement speed of a printing apparatus of the printing system of FIG. 1 over time.

FIG. 5 schematically shows once again the printing method and the printing system of FIG. 1.

FIG. 6 schematically shows structural parts 3D-printed by means of the printing method and the printing system of FIG. 1 and composed of formed strands of building material.

FIG. 7 shows a perspective view of the printing system, in particular of the printing apparatus, of FIG. 1.

FIG. 8 shows a further perspective view of the printing system, in particular of the printing apparatus, of FIG. 1.

FIG. 9 shows a front view of the printing system with the printing apparatus of FIG. 8 with at least one peripheral wall in a first setting, at least one inner element in a first setting and at least one cover element in a second setting.

FIG. 10 shows a side view of the printing system, in particular of the printing apparatus, of FIG. 9.

FIG. 11 shows a front view of the printing system with the printing apparatus of FIG. 8 with the at least one peripheral wall in the first setting, the at least one inner element in a second setting and the at least one cover element in a first setting, without an upper peripheral wall.

FIG. 12 shows a side view of the printing system, in particular of the printing apparatus, of FIG. 11.

FIG. 13 shows a front view of the printing system with the printing apparatus of FIG. 8 with the at least one peripheral wall in a second setting and the at least one inner element in the first setting, without an upper peripheral wall and without a cover element.

FIG. 14 shows a perspective view of the printing system, in particular of the printing apparatus, of FIG. 13.

FIG. 15 shows a front view of the printing system with the printing apparatus of FIG. 8 with the at least one peripheral wall in the second setting, the at least one inner element in the first setting and the at least one cover element in a third setting.

FIG. 16 shows a perspective view of the printing system, in particular of the printing apparatus, of FIG. 15.

### DETAILED DESCRIPTION OF THE EXEMPLARY EMBODIMENTS

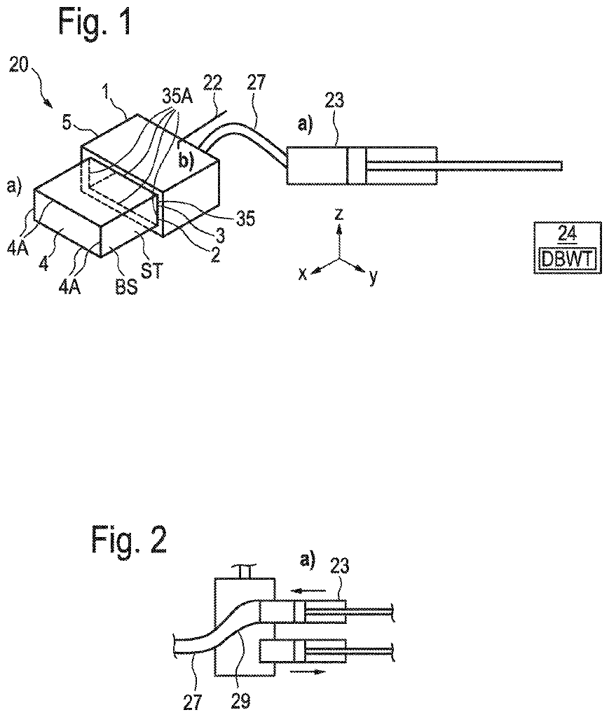

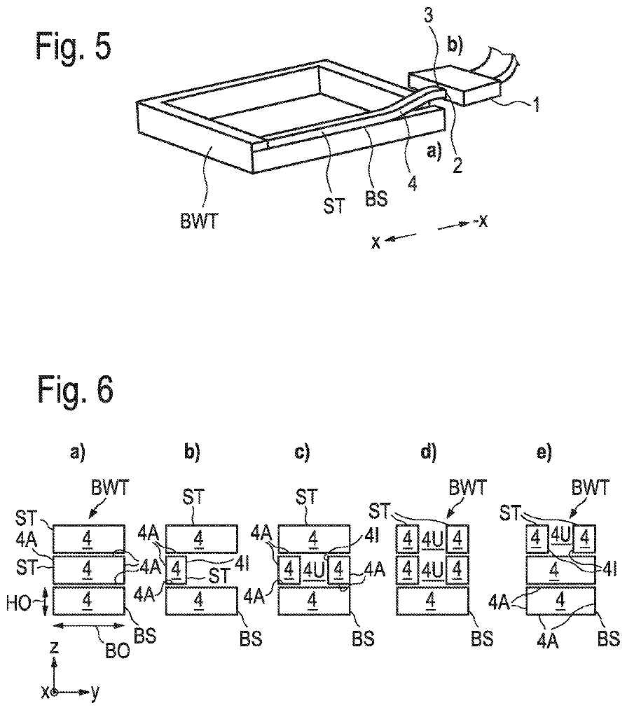

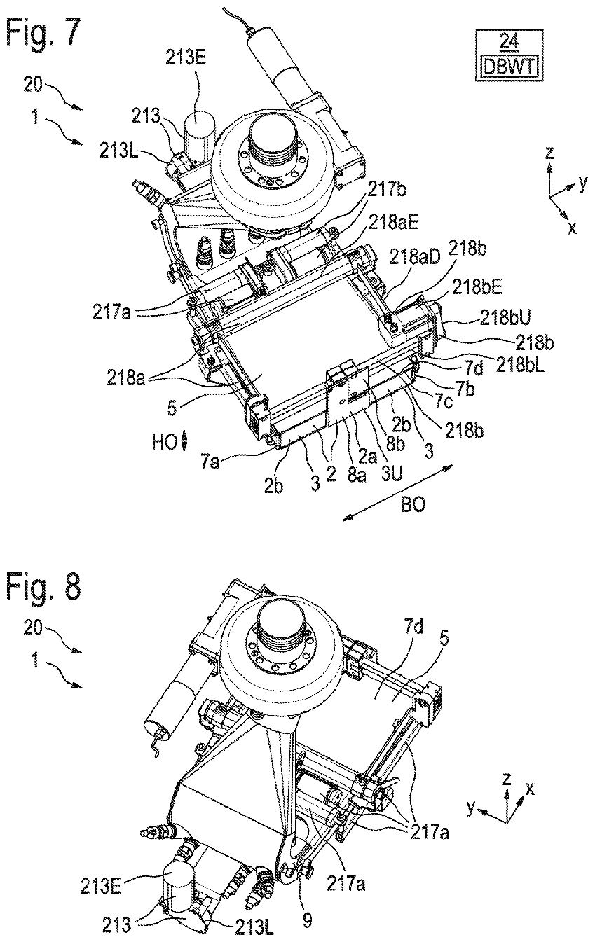

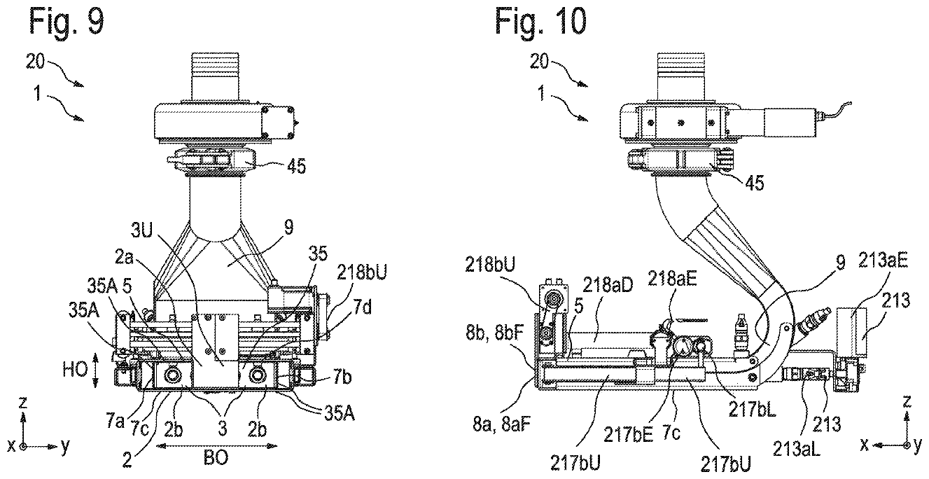

FIGS. 1 to 3, 5 and 7 to 16 show a printing system 20 for forming an in particular spatially continuous strand ST of building material BS for 3D printing of a structural part BWT. The printing system 20 has a printing apparatus 1, a discontinuous building material pump 23, a controllable movement apparatus 22 and a control device 24. The printing apparatus 1 is designed for dispensing building material BS out of the printing apparatus 1 and for shaping building material BS, in particular at a time before and/or during the dispensing, in order to form the strand ST of building material BS. The discontinuous building material pump 23 is designed to in particular chronologically, discontinuously convey building material BS for the purposes of discontinuously dispensing conveyed, and in particular shaped, building material BS out of the printing apparatus 1. The movement apparatus 22 is designed to discontinuously move the printing apparatus 1. The control device 24 is designed to control the movement apparatus 22 so as to discontinuously move the printing apparatus 1 during the discontinuous conveying and the discontinuous dispensing, and in particular the shaping, such that the dispensed and shaped building material BS forms the continuous strand ST of building material BS.

Furthermore, FIGS. 1 to 5 show a printing method for forming the continuous strand ST of building material BS for 3D printing of the structural part BWT by means of the printing system 20. The printing method has the following steps: a) discontinuously conveying building material BS by means of the discontinuous building material pump 23 and discontinuously dispensing conveyed building material BS out of the printing apparatus 1 and shaping conveyed building material BS, in particular at a time before and/or during the dispensing, by means of the printing apparatus 1; b) discontinuously moving the printing apparatus 1 during the discontinuous conveying and the discontinuous dispensing, and in particular the shaping, such that the dispensed and shaped building material BS forms the continuous strand ST of building material BS, in particular by means of the movement apparatus 22.

In particular, the printing system 20 is designed to carry out, in particular carries out, the printing method described above.

In detail, the discontinuous building material pump 23 is designed to convey building material BS in displacement cycles VT, as shown above in FIG. 4. In suction and/or switchover cycles SUT, in particular chronologically between the displacement cycles VT, a QF(t) conveying volume flow of building material BS of the building material pump 23 is discontinuous or equal to zero.

In particular, the conveying volume flow QF(t) additionally differs, in particular is smaller, at the beginning and/or at the end in relation to a middle of a, in particular each, displacement cycle VT.

In the exemplary embodiment shown, the discontinuous building material pump 23 is a piston pump, in particular a two-piston pump with an in particular switchable pipe switch 29, as shown in FIG. 2.

In particular, the conveying volume flow QF(t) is discontinuous in switchover cycles SUT, in particular of the pipe switch 29, as shown in the top and in the middle of FIG. 4.

In addition, step a) comprises: switching the pipe switch 29 so slowly that the switching of the pipe switch 29 does not cause the printing apparatus 1 to vibrate.

The printing system 20 furthermore has a building material conveying line 27, as shown in FIGS. 1 to 3. The building material conveying line 27 connects the building material pump 23 to the printing apparatus 1 for a flow of building material BS from the building material pump 23 through the building material conveying line 27 to the printing apparatus 1.

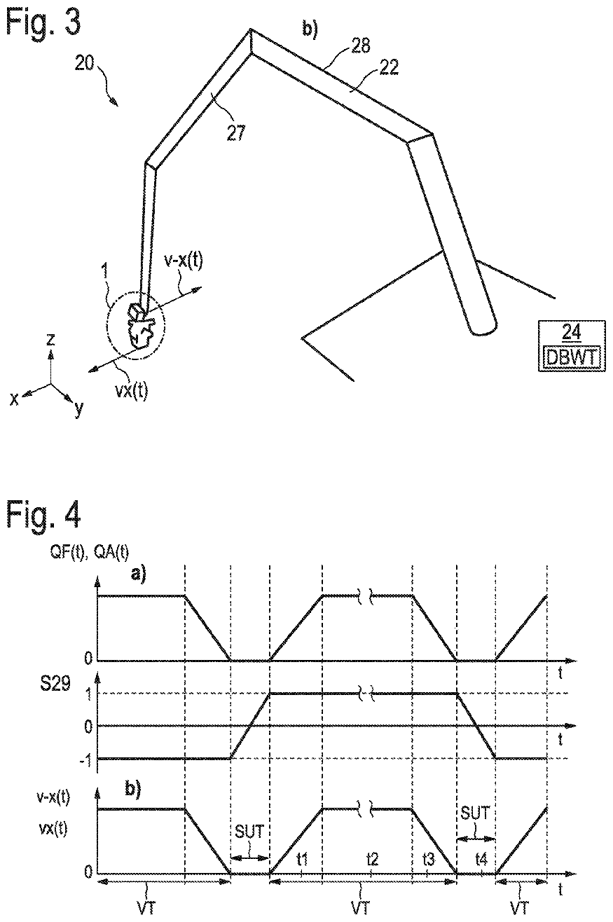

In addition, the movement apparatus 22 has a controllable arm 28, as shown in FIG. 3. The arm 28 is designed to discontinuously move the printing apparatus 1. The control device 24 is designed to control the arm 28 so as to discontinuously move the printing apparatus 1 during the discontinuous conveying and the discontinuous dispensing, and in particular the shaping, such that the dispensed and shaped building material BS forms the continuous strand ST of building material BS.

In particular, the printing system 20 is a controllable printing system. Additionally or alternatively, the printing apparatus 1 is a controllable printing apparatus. Additionally or alternatively, the building material pump 23 is a controllable building material pump. Additionally or alternatively, the control device 24 is designed to control the printing system 20 and/or the printing apparatus 1 and/or the building material pump 23 and/or the movement apparatus 22 in a manner dependent on data DBWT of the structural part BWT to be printed.

Furthermore, the printing apparatus 1 is designed to specify a strand cross section 4 of the strand ST. Step b) comprises: discontinuously moving the printing apparatus 1 such that the strand ST formed has the specified strand cross section 4.

In detail, the printing apparatus 1 has at least one discharge opening 2 with at least one shape-imparting opening cross section 3. The at least one discharge opening 2 is designed for the discharge of the strand ST, in particular with the strand cross section 4, of building material BS out of the printing apparatus 1. Step a) comprises: discontinuous discharge of the strand ST, in particular with the strand cross section 4, of building material BS out of the printing apparatus 1. Step b) comprises: discontinuously moving the printing apparatus 1 such that the strand cross section 4 of the discharged strand ST equates to the at least one opening cross section 3.

In addition, the printing apparatus 1 is designed to be adjustable for the purposes of adjustably specifying the strand cross section 4(t), in particular the at least one shape-imparting opening cross section 3(t), in particular during the dispensing of building material BS. The printing method has the step: adjusting the specification of the strand cross section 4(t), in particular of the at least one opening cross section 3(t), in particular during the dispensing of building material BS. Step b) comprises: discontinuously moving the printing apparatus 1 in a manner dependent on the adjusted specification of the strand cross section 4(t), in particular of the at least one opening cross section 3(t).

In the exemplary embodiment shown, the printing apparatus 1 has an extruder nozzle 5 and at least one specification element, in particular a shape specification element, 7a, 7b, 8a, 8b, 30a, 30b, as shown in FIGS. 7 to 16. The extruder nozzle 5 has the in particular rectangular discharge opening 2 for the discharge of the strand ST of building material BS out of the printing apparatus 1 in an in particular horizontal dispensing or discharge direction x. The at least one specification element 7a, 7b, 8a, 8b, 30a, 30b is designed or configured or mounted to be in particular individually or separately, variably, in particular continuously, settable or adjustable, in particular movable, in particular into at least two different settings, for the purposes of variably, in particular continuously, settably and/or adjustably specifying, in particular specifying the shape, of at least one part 4A, 4I of the in particular rectangular strand cross section 4 of the strand ST of building material BS that is being discharged and in particular has been discharged, in particular during the discharge of the strand ST of building material BS.

In detail, the extruder nozzle 5 has multiple peripheral walls 7a, 7b, 7c, 7d, four in the exemplary embodiment shown. The peripheral walls 7a, 7b, 7c, 7d peripherally define or delimit the discharge opening 2. The at least one specification element has at least one of the peripheral walls 7a, 7b, two in the exemplary embodiment shown. The at least one peripheral wall 7a, 7b has a variably settable design for the variably settable definition and/or delimitation of an outer edge or outer part 35A of an in particular shape-imparting and/or rectangular flow cross section 35 of building material BS within the extruder nozzle 5 for the purposes of variably settably specifying an outer edge or outer part 4A of the strand cross section 4.

In the exemplary embodiment shown, one, in particular a left-hand, peripheral wall 7a and one, in particular a right-hand, peripheral wall 7b are in particular each designed to be variably settable, in particular movable in/counter to a first peripheral direction y, for the purposes of variably setting a width of the flow cross section 35 for the purposes of variably setting a width of the strand cross section 4 or an opening width BO of the discharge opening 2. Additionally or alternatively, in alternative exemplary embodiments, one, in particular a lower, peripheral wall and/or one, in particular an upper, peripheral wall may in particular each be designed to be variably settable, in particular movable in/counter to a second peripheral direction, for the purposes of variably setting a height of the flow cross section for the purposes of variably setting a height of the strand cross section or an opening height of the discharge opening.

In a first setting shown in FIGS. 7 to 12, the two peripheral walls 7a, 7b are in particular each arranged as far to the outside as possible, or with a maximum spacing to one another, such that the width of the flow cross section 35 and thus the width of the strand cross section 4 or the opening width BO of the discharge opening 2 is set to a maximum or to be wide, in the exemplary embodiment shown 400 mm.

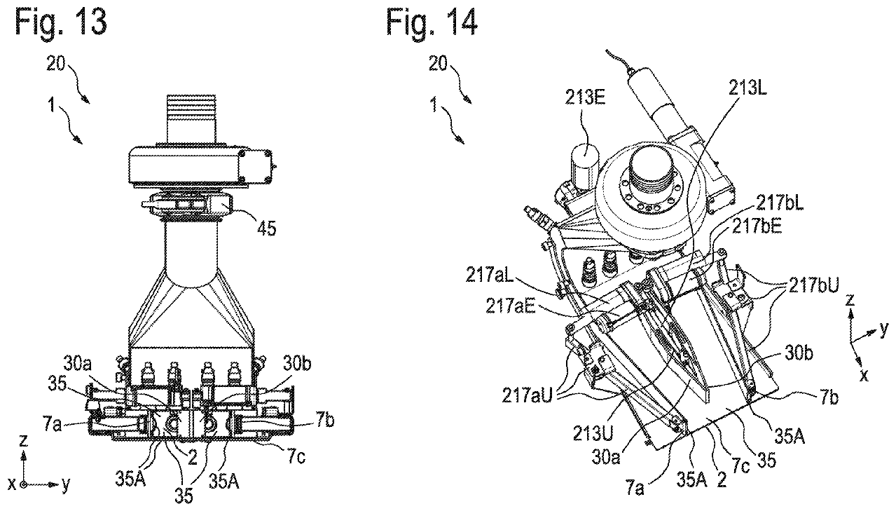

In a second setting shown in FIGS. 13 to 16, which in particular differs from the first setting, the two peripheral walls 7a, 7b are in particular each arranged as far to the inside as possible, or with a minimum spacing to one another, or so as to be as close together as possible, such that the width of the flow cross section 35 and thus the width of the strand cross section 4 or the opening width BO of the discharge opening 2 is set to a minimum or to be narrow, in the exemplary embodiment shown 200 mm.

In the exemplary embodiment shown, an opening height HO of the discharge opening 2 is 50 mm, in particular in the second peripheral direction z.

Furthermore, the at least one specification element has at least one inner element 30a, 30b. The at least one inner element 30a, 30b has a variably settable design, in particular is movable relative to the extruder nozzle 5 in particular in/counter to the first peripheral direction y, for variably settable, in particular complete, arrangement within the extruder nozzle 5 for the purposes of variably settable definition or delimitation of in particular at least one inner edge or inner part 35I of the flow cross section 35 of building material BS within the extruder nozzle 5 for the purposes of variably settable specification of in particular at least one inner edge or inner part 4I of the strand cross section 4. In alternative exemplary embodiments, the at least one inner element may additionally or alternatively be movable in/counter to the second peripheral direction.

In the exemplary embodiment shown, the at least one specification element has in particular exactly two inner elements 30a, 30b. In alternative exemplary embodiments, the at least one specification element may have in particular only one or at least three inner elements.

In detail, the at least one inner element 30a, 30b, in a first, in particular inner, setting, in particular does not specify an inner edge of the flow cross section 35 and thus does not specify an inner edge of the strand cross section 4, as shown in FIGS. 7 to 10 and 13 to 16 and FIG. 6 a), b) at the bottom and top, c) at the bottom and top, d) at the bottom and e) at the bottom and in the middle.

Additionally or alternatively, in a second, in particular outer setting, the at least one inner element 30a, 30b specifies a division into two parts by means of an in particular rectangular interruption 4U, in particular in an particular horizontal direction, in particular in the first peripheral direction y, in particular of the flow cross section 35, and thus of the strand cross section 4, as shown in FIGS. 11 and 12 and FIG. 6 b) in the middle, c) in the middle, d) in the middle and at the top and e) at the top.

Furthermore, the at least one specification element comprises at least one in particular rectangular cover element 8a, 8b. The at least one cover element 8a, 8b has a variably settable design, in particular is movable, in particular in/counter to the first peripheral direction y and/or second peripheral direction z, relative to the discharge opening 2 or the extruder nozzle 5, for the variably settable covering of at least one part 2a of the discharge opening 2 for the variably adjustable specification of at least one part or edge 4A, 4I, in particular of the outer edge 4A and/or of the inner edge 4I, of the strand cross section 4 by at least one uncovered part 2b of the discharge opening 2, in particular of the opening cross section 3 of the discharge opening 2.

In the exemplary embodiment shown, the at least one specification element has in particular exactly two in particular rectangular cover elements 8a, 8b. In alternative exemplary embodiments, the at least one specification element may have in particular only one or at least three cover elements.

In detail, the at least one cover element 8a, 8b is designed to cover the, in particular at least one, part 2a of the discharge opening 2 such that the opening cross section 3 is at least divided into two parts with an interruption 3U, in particular in an in particular horizontal direction, in particular in the first peripheral direction y.

In particular, the at least one cover element 8, 8a, 8b is designed to be variably settable for the purposes of separating off, in particular cutting off, the discharged strand ST of building material BS from the printing apparatus 1, in particular from the extruder nozzle 5, in particular at the discharge opening 2.

In the exemplary embodiment shown, the at least one cover element 8a, 8b has a cutting plate or a blade 8aK, 8bK.

Furthermore, in the exemplary embodiment shown, the at least one cover element 8, 8a, 8b is designed to be arranged on the discharge opening 2, in particular so as to be in contact with the extruder nozzle 5. This makes it possible to reduce or even avoid an unintended escape of building material out of the printing apparatus, in particular the extruder nozzle, at an unintended location and/or in/counter to the first peripheral direction and/or the second peripheral direction.

In a second setting shown in FIGS. 7 to 10, the two cover elements 8a, 8b are arranged on the discharge opening 2 and cover an in particular inner and/or rectangular part 2a of the discharge opening 2 such that the opening cross section 3 is in particular rectangular and is divided into two parts with an in particular rectangular interruption 3U, in particular in the first peripheral direction y. In other words: two parts 2b of the discharge opening 2, which are in particular outer parts or parts separated from one another by the two cover elements 8a, 8b, are uncovered. In detail, the cover elements 8a, 8b overlap or are pushed one over the other in the discharge direction x. The two-part, in particular rectangular opening cross section 3 with the in particular rectangular interruption 3U thus specifies the two-part, in particular rectangular, strand cross section 4 with an in particular rectangular interruption 4U of the in particular discharged strand ST of building material BS.

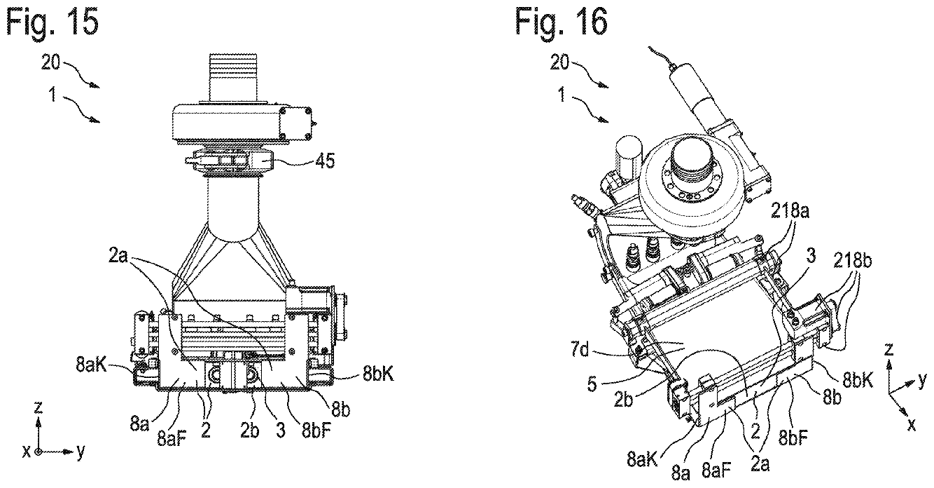

In a third setting which is shown in FIGS. 15 and 16 and which in particular differs from the second, the two cover elements 8a, 8b are arranged on the discharge opening 2 and cover two in particular outer and/or rectangular parts 2a of the discharge opening 2 such that the opening cross section 3 is in particular rectangular and narrow, in particular in the first peripheral direction y. In other words: an in particular inner part 2b of the discharge opening 2 is uncovered. The narrow, in particular rectangular opening cross section 3 thus specifies the narrow, in particular rectangular strand cross section 4 of the in particular discharged strand ST of building material BS. Additionally or alternatively, by movement from/to the setting shown in FIGS. 7 to 10 to/from the setting shown in FIGS. 15 and 16 of the two cover elements 8a, 8b, in particular in/counter to the first peripheral direction y, the in particular discharged strand ST of building material BS is separated off from the printing apparatus 1.

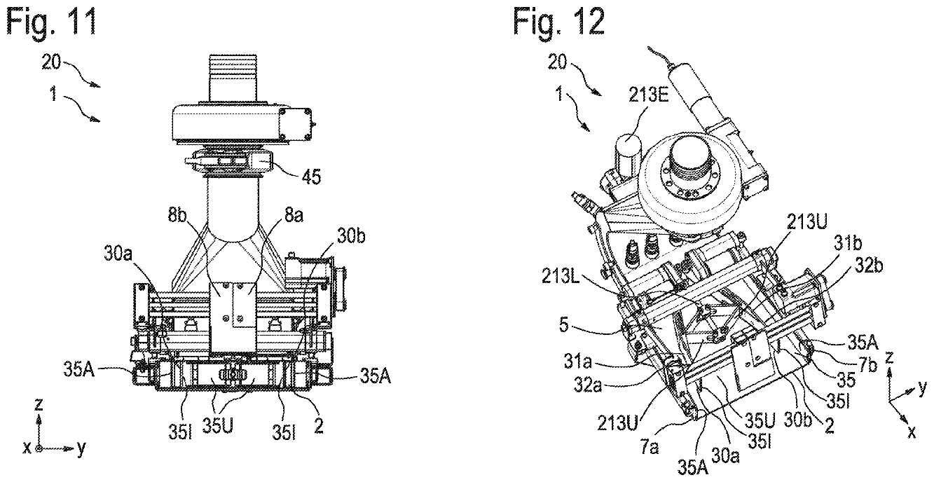

In a first setting which is shown in FIGS. 11 and 12 and which in particular differs from the second and third, the two cover elements 8a, 8b are not arranged on the discharge opening 2 and do not cover any part of the discharge opening 2, or the discharge opening 2 is uncovered. In other words: the two cover elements 8a, 8b have been lifted off in the second peripheral direction z.

In particular, FIG. 6 schematically shows, by way of the printing method and the printing system 20, 3D-printed structural parts BWT composed of strands ST of building material BS formed and in particular layered or deposited one on top of the other.

In detail, the rectangular strand cross section 4 shown in particular in each case in FIG. 6 a), b) at the bottom and top, c) at the bottom and top, d) at the bottom and e) at the bottom may be specified or is specified by the peripheral walls 7a, 7b, in particular in each case in the first setting or as far to the outside as possible, the at least one inner element 30a, 30b in the first setting and the at least one cover element 8a, 8b in the first setting or without a cover element.

The rectangular, two-part strand cross section 4 with rectangular interruption 4U, as shown in particular in each case in FIG. 6 c) in the middle, d) in the middle and at the top and e) at the top, may be specified or is specified by the peripheral walls 7a, 7b, in particular in each case in the first setting or as far to the outside as possible, the at least one inner element 30a, 30b in the second setting and the at least one cover element 8a, 8b in the first setting or without a cover element.

Additionally or alternatively, the rectangular, two-part strand cross section 4 with rectangular interruption 4U, as shown in particular in each case in FIG. 6 c) in the middle, d) in the middle and at the top and e) at the top, may be specified or is specified by the peripheral walls 7a, 7b, in particular in each case in the first setting or as far to the outside as possible, the at least one inner element 30a, 30b in the first setting and the at least one, in particular rectangular, cover element 8a, 8b in the second setting or covering a middle or inner part 2a of the in particular rectangular discharge opening 2, in particular with a maximum opening width BO.

The rectangular strand cross section 4 shown in FIG. 6 b) in the middle may be specified or is specified by the peripheral wall 7a in the first setting or as far to the outside as possible, the peripheral wall 7b in the second setting or as far to the inside as possible, the at least one inner element 30a, 30b in the second setting and the at least one cover element 8a, 8b in the first setting or without a cover element.

Additionally or alternatively, the rectangular strand cross section 4 shown in FIG. 6 b) in the middle may be specified or is specified by the peripheral wall 7a in the first setting or as far to the outside as possible, the peripheral wall 7b in the second setting or as far to the inside as possible, the at least one inner element 30a, 30b in the first setting and the at least one in particular rectangular cover element 8a, 8b in the second setting or covering a middle or inner part 2a of the in particular rectangular discharge opening 2, in particular with a maximum opening width BO.

It is thus possible for slots be produced vertically in a strand or a layer or a ply ST and horizontally on an outer side of the strand ST, as shown in FIG. 6, in particular b) to e). In particular, it is thus possible to generate two narrow or thin structural parts or walls BWT which are connected by means of webs and which have a passage, in order for the intermediate space to later be filled with insulation material or to accommodate installation lines. In particular, the strand cross sections 4 of FIGS. 6 c), d) and e) may be arranged in particular in this sequence in and/or counter to the dispensing or discharge direction x. In addition or alternatively, it is thus possible to produce open strand cross sections 4 in order to generate a media channel. In particular, the strand cross sections 4 of FIGS. 6 a), b), c) and d) may be arranged in particular in this sequence in and/or counter to the dispensing or discharge direction x. Further additionally or alternatively, a support structure such as a lattice may be arranged on and/or is arranged those strands ST which do not extend over the entire maximum opening width BO, in order to allow at least one further strand ST to be deposited. This can make it possible to prevent soft building material from sagging downward into the space, in particular hollow space.

In addition, the printing system 20, in particular the printing apparatus 1, has at least one in particular controllable and/or electrical setting apparatus or adjusting apparatus 213, 217a, 217b, 218a, 218b. The at least one setting apparatus 213, 217a, 217b, 218a, 218b is designed for the in particular automatic, variable, in particular continuous setting or adjustment of the at least one specification element 7a, 7b, 8a, 8b, 30a, 30b.

Furthermore, the control device 24 is designed to control the at least one setting apparatus 213, 217a, 217b, 218a, 218b in a manner dependent on data DBWT of the structural part BWT to be printed.

In addition, the printing method has the step: depositing the dispensed building material BS, in particular by means of the printing apparatus 1 and/or the movement apparatus 22. Step b) comprises: discontinuously moving the printing apparatus 1 such that the deposited building material BS forms the continuous strand ST of building material BS, in particular such that the deposited strand ST has the specified strand cross section 4, in particular the at least one opening cross section 3, or maintains its strand cross section 4.

Furthermore, step a) comprises: discontinuously dispensing, in particular discontinuous discharge, of building material BS out of the printing apparatus 1 in the in particular horizontal dispensing direction x. Step b) comprises: discontinuously moving the printing apparatus 1 in a movement direction −x that is non-orthogonal, in particular opposite, with respect to the dispensing direction x, as shown in FIG. 3.

In detail, the printing apparatus 1 has a deflecting device or a deflecting element 9, as shown in FIGS. 7 to 16. The deflecting device 9 is arranged upstream of the discharge opening 2, in particular of the extruder nozzle 5, and is designed to deflect a flow or a stream of building material BS, in particular from a pipe flange 45, in particular from a non-horizontal, in particular vertical, direction, in particular counter to the first peripheral direction −z, in particular from top to bottom, in the direction, in particular in the dispensing or discharge direction x, in particular from rear to front, of the discharge opening 2.

Furthermore, the movement apparatus 22 and/or the printing apparatus 1 are/is designed to move the printing apparatus 1 in rotation, in particular during the conveying and/or the dispensing and in particular the shaping. In detail, the printing apparatus 1 is rotatable about a longitudinal axis of the pipe flange.

Step b) furthermore comprises: discontinuously moving the printing apparatus 1 in a manner dependent on the discontinuous conveying and the discontinuous dispensing.

In detail, step a) comprises: discontinuously conveying building material BS with the discontinuous conveying volume flow QF(t) and/or discontinuously dispensing building material BS out of the printing apparatus 1 with a discontinuous dispensing volume flow QA(t) and/or a discontinuous dispensing speed vx(t), as shown in FIG. 4.

In addition, step b) has: discontinuously moving the printing apparatus 1 at a discontinuous movement speed v−x(t) such that the movement speed v−x(t) is proportional to the conveying volume flow QF(t) and/or to the dispensing volume flow AQ(t), in particular equal to the dispensing volume flow QA(t) divided by the strand cross section 4(t) or the opening cross section 3(t): v−x(t)=QA(t)/4(t) and/or v−x(t)=QA(t)/3(t).

Additionally or alternatively, step b) has: discontinuously moving the printing apparatus 1 at the discontinuous movement speed v−x(t) such that the movement speed v−x(t) is proportional to the dispensing speed vx(t), in particular equal to the dispensing speed vx(t): v−x(t)=vx(t).

This results in the in particular chronological course of the movement speed v−x(t) shown at the bottom in FIG. 4.

In detail: at the beginning of the displacement cycle VT, in particular at a point in time t1, the conveying volume flow QF(t) and thus the dispensing volume flow QA(t) is greater than zero but small. The movement speed v−x(t) is thus greater than zero but small. In the middle of the displacement cycle VT, in particular at a point in time t2 that chronologically follows the point in time t1, the conveying volume flow QF(t) and thus the dispensing volume flow QA(t) is greater than zero, in particular large. The movement speed v−x(t) is thus greater than zero, in particular large. At the end of the displacement cycle VT, in particular at a point in time t3 that chronologically follows the point in time t2, the conveying volume flow QF(t) and thus the dispensing volume flow QA(t) is greater than zero but small. The movement speed v−x(t) is thus greater than zero but small. In the suction and/or switchover cycle SUT, in particular at a point in time t4 that chronologically follows the point in time t3, the conveying volume flow QF(t) and thus the dispensing volume flow QA(t) is discontinuous or equal to zero. The movement speed v−x(t) is thus discontinuous or equal to zero.

If the movement speed, in particular in the suction and/or switchover cycles, were continuous or greater than zero, then the in particular formed and/or deposited strand would be discontinuous and/or would not have the specified strand cross section, in particular the at least one opening cross section, in particular in an unintended manner.

In addition, the printing apparatus 1 has a number of in particular controllable injection nozzles, in particular cyclically operated high-pressure nozzles with a pressure greater than 10 bar, in particular greater than 100 bar, as shown in FIGS. 7 to 16. The injection nozzles are designed for injecting, in particular for admixing or introducing, an additive, in particular concrete accelerator, in particular directly into the building material BS before it is dispensed or discharged. This, in particular the high pressure, allows the additive to be widely distributed such that no further mixing element is required. In detail, the number of injection nozzles is arranged in the first peripheral direction z above the extruder nozzle 5 or the peripheral wall 7d and/or behind the extruder nozzle 5, and in particular the deflecting device 9, counter to the dispensing or discharge direction −x. This, in particular the arrangement, makes it possible that, in pumping intervals or interruptions in the printing process, the smallest possible amount of activated building material, in particular concrete, is present in the printing apparatus 1 and/or has to be disposed of.

Furthermore, the control device 24 is designed to control the number of injection nozzles in a manner dependent on data DBWT of the structural part BWT to be printed.

As is made clear by the exemplary embodiments shown and discussed above, the invention provides an advantageous printing method for forming a continuous strand of building material for 3D printing of a structural part by means of a printing system, and provides a printing system for forming a continuous strand of building material for 3D printing of a structural part, which in particular in each case has improved characteristics, in particular allows more degrees of freedom.

1.-15. (canceled)

16. A printing method for forming a continuous strand of building material for 3D printing of a structural part via a printing system,
wherein the printing system comprises:
a printing apparatus, wherein the printing apparatus is designed to dispense building material out of the printing apparatus and to shape the building material to form a strand of building material, and
a discontinuous building material pump, wherein the discontinuous building material pump is designed to discontinuously convey building material for purposes of discontinuously dispensing conveyed building material out of the printing apparatus,
wherein the printing method comprises the steps of:
a) discontinuously conveying building material via the discontinuous building material pump and discontinuously dispensing conveyed building material out of the printing apparatus and shaping conveyed building material via the printing apparatus; and
b) discontinuously moving the printing apparatus during the discontinuous conveying and the discontinuous dispensing such that the dispensed and shaped building material forms a continuous strand of building material.

17. The printing method as claimed in claim 16,
wherein the discontinuous building material pump is designed to convey building material in displacement cycles, wherein, in suction and/or switchover cycles between the displacement cycles, a conveying volume flow of building material of the building material pump is discontinuous.

18. The printing method as claimed in claim 16, wherein
the discontinuous building material pump is a piston pump.

19. The printing method as claimed in claim 18, wherein
the discontinuous building material pump is a two-piston pump with a pipe switch.

20. The printing method as claimed in claim 19, wherein
step a) comprises:
switching the pipe switch slowly so that the switching of the pipe switch does not cause the printing apparatus to vibrate.

21. The printing method as claimed in claim 16,
wherein the printing apparatus is designed to specify a strand cross section of the strand, and
wherein step b) comprises:
discontinuously moving the printing apparatus such that the strand formed has the specified strand cross section.

22. The printing method as claimed in claim 21,
wherein the printing apparatus has at least one discharge opening with at least one shape-imparting opening cross section, the at least one discharge opening being configured for the discharge of the strand with the strand cross section of building material out of the printing apparatus, and
wherein step a) comprises:
discontinuous discharge of the strand with the strand cross section of building material out of the printing apparatus, and
wherein step b) comprises:
discontinuously moving the printing apparatus such that the strand cross section of the discharged strand equates to the at least one opening cross section.

23. The printing method as claimed in claim 21,
wherein the printing apparatus is designed to be adjustable for purposes of adjustably specifying the strand cross section during the dispensing of building material,
wherein the printing method further comprises the step of:
adjusting the specification of the strand cross section during the dispensing of building material, and
wherein step b) comprises:
discontinuously moving the printing apparatus in a manner dependent on the adjusted specification of the strand cross section.

24. The printing method as claimed in claim 16,
wherein step a) comprises:
discontinuously dispensing of building material out of the printing apparatus in a horizontal dispensing direction, and
wherein step b) comprises:
discontinuously moving the printing apparatus in a movement direction which is non-orthogonal with respect to the dispensing direction.

25. The printing method as claimed in claim 16,
wherein step b) comprises:
discontinuously moving the printing apparatus in a manner dependent on the discontinuous conveying and the discontinuous dispensing.

26. The printing method as claimed in claim 25,
wherein step a) comprises:
discontinuously conveying building material with a discontinuous conveying volume flow and/or discontinuously dispensing building material out of the printing apparatus with a discontinuous dispensing volume flow and/or a discontinuous dispensing speed, and
wherein step b) comprises:
discontinuously moving the printing apparatus at a discontinuous movement speed in such a way that:
the movement speed is proportional to the conveying volume flow and/or to the dispensing volume flow, and/or
the movement speed is proportional to the dispensing speed.

27. The printing method as claimed in claim 26, wherein
the movement speed is equal to the dispensing volume flow divided by the strand cross section or the opening cross section, and/or
the movement speed is equal to the dispensing speed.

28. The printing method as claimed in claim 16, wherein the printing method further comprises the step of:
depositing the dispensed building material, and
wherein step b) comprises:
discontinuously moving the printing apparatus such that the deposited building material forms the continuous strand of building material.

29. A printing system for forming a continuous strand of building material for 3D printing of a structural part, comprising:
a printing apparatus, wherein the printing apparatus is designed to dispense building material out of the printing apparatus and to shape the building material to form a strand of building material;
a discontinuous building material pump, wherein the discontinuous building material pump is designed to discontinuously convey building material for purposes of discontinuously dispensing conveyed building material out of the printing apparatus;
a controllable movement apparatus, wherein the movement apparatus is designed to discontinuously move the printing apparatus; and
a control device, wherein the control device is designed to control the movement apparatus so as to discontinuously move the printing apparatus during the discontinuous conveying and the discontinuous dispensing such that the dispensed and shaped building material forms a continuous strand of building material.

30. The printing system as claimed in claim 29,
wherein the movement apparatus has a controllable arm, the arm being designed to discontinuously move the printing apparatus, and
wherein the control device is designed to control the arm so as to discontinuously move the printing apparatus during the discontinuous conveying and the discontinuous dispensing such that the dispensed and shaped building material forms the continuous strand of building material.

31. The printing system as claimed in claim 29, further comprising:
a building material conveying line, wherein the building material conveying line connects the building material pump to the printing apparatus for a flow of building material from the building material pump through the building material conveying line to the printing apparatus.

32. The printing system as claimed in claim 29, wherein at least one of:
the printing system is a controllable printing system,
the printing apparatus is a controllable printing apparatus,
the building material pump is a controllable building material pump,
the control device is designed to control the printing system, the printing apparatus, the building material pump, and/or the movement apparatus in a manner dependent on data of the structural part to be printed.
